(19) United States
(12) Patent Application Publication
(10) Pub. No.: US 2005/0064834 A1
(43) Pub. Date: Mar. 24, 2005

(54) Control method for the AGC unit of a radio receiver

(75) Inventor: Attila Bilgic, Kirchheim (DE)

Correspondence Address: Andreas Grubert;Baker Botts L.L.P., One Shell Plaza, 910 Louisiana, Houston, TX, 77002-4995, US

(73) Assignee: Infineon Technologies AG

(21) Appl. No.: 10/947,478

(22) Filed: Sep. 22, 2004

(30) Foreign Application Priority Data
Sep. 23, 2003 (DE) DE 103 44 089.5

(51) Int. Cl. H04Q 7/20; H04B 7/00; H04B 1/06; G05B 13/02

(52) U.S. Cl. 455/234.2; 455/422.1

(57) ABSTRACT

In a method for determination of controller settings for a control loop for controlling the reception signal strength of a radio receiver, the transfer function for that part of the signal path of the radio receiver which forms the controlled section (4, 10) of the control loop is known at least approximately as a function. The controller settings are determined by calculation, by optimization of the overall transfer function of the control loop with respect to a desired optimality criterion, taking into account the known function.

### PRIORITY

This application claims priority to German application no. 103 44 089.5 filed Sep. 23, 2003.

### TECHNICAL FIELD OF THE INVENTION

The present invention relates to a method for controlling the regulation of the reception signal strength in a mobile radio receiver.

In mobile radio systems, the signals are transmitted on radio paths with different propagation characteristics, so that the received signal strength at the antenna of the mobile receiver is subject to considerable fluctuations. By way of example, the 3GPP Standard for UMTS FDD (Universal Mobile Telecommunications System, Frequency Division Duplex) specifies, in Technical Specification 25.101, a received signal strength fluctuation from −25 dBm to −106.7 dBm at the antenna, that is to say a range of more than 80 dB, or more than four orders of magnitude. It is advantageous to counteract these major fluctuations in the reception signal strength even before the signal is sampled by the analogue/digital converter in the receiver. The analogue/digital converter is therefore preceded by controllable amplification. The object of this controllable amplification is to keep the signal strength at the input of the analogue/digital converter constant, or within predetermined tolerances.

The gain is normally controlled by simple controllers whose internal parameters (controller settings) are optimized empirically. The control algorithm is in this case implemented on a DSP (digital signal processor), to which the necessary input variables, such as the signal strength, are supplied, for example after digitization by the analogue/digital converter. Specific variables of the analogue or digital input circuit of the radio receiver are in this case ignored. An apparatus such as this is frequently referred to as an AGC (automatic gain controller).

Empirical determination of the controller settings has the disadvantage that the control loop does not have a defined convergence response, and that no such convergence response can be guaranteed. Furthermore, the control process is inflexible in different environments and different receiver states.

### SUMMARY OF THE INVENTION

One object of the invention is thus to specify an improved method by means of which the controller settings can be determined. A further object of the invention is to specify a method which ensures improved matching of the controller to different radio conditions.

The object can be achieved by a method for determination of controller settings for a control loop for controlling the reception signal strength in a radio receiver, with the transfer function being known at least approximately as a function for that part of the signal path of the radio receiver which forms the controlled section of the control loop, comprising the step of determining the controller settings computationally by optimization of the overall transfer function of the control loop with respect to a desired optimality criterion, taking into account the known function.

The object can also be achieved by a method for controlling the reception signal strength in a radio receiver by means of a control loop, which comprises a controller with variable controller settings which can be predetermined, comprising the steps of operating the controller with first controller settings; and operating the controller with second controller settings, which are not the same as the first controller settings.

The object can furthermore be achieved by a method for controlling the reception signal strength in a radio receiver by means of a control loop, which comprises a controller with variable controller settings which can be predetermined, comprising the steps of operating the controller with first controller settings; and operating the controller with second controller settings, which are not the same as the first controller settings; wherein the first and second controller settings are calculated in advance by means of method for determination of controller settings for a control loop for controlling the reception signal strength in a radio receiver, with the transfer function being known at least approximately as a function for that part of the signal path of the radio receiver which forms the controlled section of the control loop, comprising the steps of determining the controller settings computationally by optimization of the overall transfer function of the control loop with respect to a desired optimality criterion, taking into account the known function, and storing the controller settings in the radio receiver.

The invention is based on the idea of the controller settings for a control loop for controlling the reception signal strength in a radio receiver in which the transfer function of that part of the signal path which forms the controlled section of the control loop is known at least approximately as a function not being determined empirically or being defined on an arbitrary basis, but being determined computationally. This is achieved by optimization of the overall transfer function of the control loop with the assistance of the known function, which describes the transfer function of the controlled section, with respect to a desired optimality criterion. The consideration according to the invention of the receiver characteristic, expressed by the known transfer function of the controlled section, makes it possible to deliberately match the response of the controller to the desired optimality criterion, and thus to control it. This makes it possible to ensure that the control loop always has a known and defined convergence response.

In one advantageous refinement of the invention, the optimality criterion comprises a predetermined, well-defined convergence response of the controlled reception signal strength. In one particularly preferred refinement of the invention, the desired convergence response requires extremely fast convergence of the controlled reception signal strength. In this case, convergence essentially takes place within the time period for the controller to determine a new manipulated variable. In a further preferred refinement of the invention, the desired convergence response is defined by a predetermined time profile. This profile comprises, for example, slow convergence of the controlled reception signal strength, averaging out short-term signal fluctuations.

In a further advantageous refinement of the invention, the transfer function of the controlled section is at least partially stored in one or more look-up tables. These look-up tables are determined by system simulations or by analytical calculation of the controlled section. The look-tables make it possible to represent and to model any desired transfer function.

In a further advantageous refinement, the transfer function of the controlled section is defined in the form of functions which can be represented analytically. The coefficients of the analytical functions in this case form the so-called controlled section parameters. In one particularly preferred refinement, the analytical functions are formed by linear or partially linear functions.

In a further advantageous refinement of the invention, the overall transfer function of the control loop is defined completely by two or more functions which can be represented in analytical form. In this case, the overall transfer function of the control loop can be described analytically in the form of an impulse response or a transfer function. The desired optimality criterion can be incorporated in a simple manner in this description of the overall transfer function of the control loop, and the associated controller setting can be determined, or at least constrained, analytically. In one particularly preferred refinement of the invention, the overall transfer function of the control loop is defined completely by two or more linear or partially linear functions.

In a further advantageous refinement of the invention, different controller settings are defined for different optimality criteria. The different optimality criteria are in this case determined, for example, by different radio receiver operating modes. This is the case in particular in UMTS radio receivers, for which the 3GPP Standard defines different operating modes. In one particularly preferred refinement of the invention, the different operating modes comprise the normal mode and the compression mode, as described in Technical Specification 25.133 for the 3GPP Standard for UMTS FDD. The normal mode and compression mode differ, inter alia, in the requirements for the convergence response of the controlled reception signal strength. In the compression mode, the transmission power levels of two or more signals are measured by the UMTS radio receiver in different base stations within a small number of time slots. In the compression mode, it is therefore advantageous for the controlled reception signal strength to be converged rapidly, in considerably less than one time slot period. Ideally, the optimality criterion includes the requirement for the convergence to take place essentially within the time period for the controller to determine a new manipulated variable. This forces the fastest possible convergence. In addition, the frequency with which the controller determines new values of the manipulated variable can be increased so that, for example, two or manipulated variables are determined in each time slot.

In a further advantageous refinement of the invention, different optimality criteria result in the overall transfer function being optimized with respect to different environmental conditions of the radio receiver. Environmental conditions such as these are represented, for example, by different relative speeds of the radio receiver with respect to the transmission station.

In a further advantageous refinement of the invention, the overall transfer function of the control loop is also influenced by a further transmission path, which represents a map of the values at the controller output onto suitable values of the manipulated variable (that is to say the input variable to the amplifier) for the controlled section. The further transfer function is described, for example, by a further look-up table. In one preferred refinement, this further transmission path is described by a further analytical function, in particular a linear or partially linear function. Suitable choice of the coefficients allows the controller output to be matched to any desired value range for the manipulated variable, and allows any non-linearities to be compensated for when using a function which is linear in places. The coefficients of the further transmission path may, however, also be included in the optimization process for the controller, and then form additional setting values for the controller. This results in further degrees of freedom for optimization of the overall transfer function of the control loop.

In one advantageous refinement of the invention, that part of the signal path of the radio receiver which forms the controlled section of the control loop comprises a variable gain analogue amplifier, an analogue/digital converter, one or more digital filters and a power calculation unit. The power calculation unit in this case averages the power of the controlled reception signal strength over a predetermined time period, the so-called integration time, and provides the measurement variable as an input variable to the controller. The frequency with which the power calculation unit produces new measurement variables corresponds to the frequency with which the controller calculates new values of the manipulated variable. The frequency at which the controller determines new values of the manipulated variable is increased in particular by shortening the integration time of the power calculation unit. The manipulated variable for the control loop controls the gain of the analogue amplifier. For this purpose, the signal at the output of the controller is supplied to the amplifier directly or after mapping by means of the further transmission path.

In a further advantageous refinement, the controller comprises a proportional branch and an integral branch, with the controller settings comprising the coefficients of the proportional branch and of the integral branch.

The present invention also relates to a method for controlling the reception signal strength in a radio receiver by means of a control loop which comprises a controller with variable controller settings which can be predetermined, with the controller being operated with a first controller setting in a first method step and being operated with second controller settings, which are not the same as the first controller settings, in a second method step. Presetting different controller settings allows the controller to be flexibly matched to different requirements for the controller mechanism, and to be switched between different radio conditions. This results in controllable regulation, in which the controller always has a control response which is matched to the respective prevailing conditions and requirements, and thus optimizes the overall transfer function of the control loop.

In one advantageous refinement of the invention, the controller settings are calculated in advance for different conditions and requirements, using the method according to the invention for determination of controller settings. Matched controller settings in the form of selectable parameter sets are made available to the controller for each of these different conditions. The conditions may in this case comprise the signal at the controller output, which is used as a measure of the reception signal strength at the antenna, the desired optimality criterion, the transmission mode of the radio receiver, the environmental conditions and/or the relative speed of the radio receiver with respect to the base station.

In one particularly preferred refinement of the invention, the controller is switched during operation on entering the compression mode and on returning to the normal mode, that is to say new controller settings are selected, which provide the respectively desired convergence response of the controlled reception signal strength.

The method according to the invention allows the response of the controller to be monitored over a wide range, and compared to the known procedures, results in a considerable degree of additional flexibility.

The invention relates not only to the described refinements, but also extends to all possible combinations of the refinements.

### BRIEF DESCRIPTION OF THE DRAWINGS

Various exemplary embodiments of the invention will be described in the following text with reference to the drawings, in which:

FIG. 1 shows a schematic illustration of an AGC unit;

FIG. 2 shows an equivalent model of the AGC unit on a logarithmic scale; and

FIG. 3 shows a reduced equivalent model of the AGC unit with a PI controller.

### DETAILED DESCRIPTION OF THE PREFERRED EMBODIMENTS

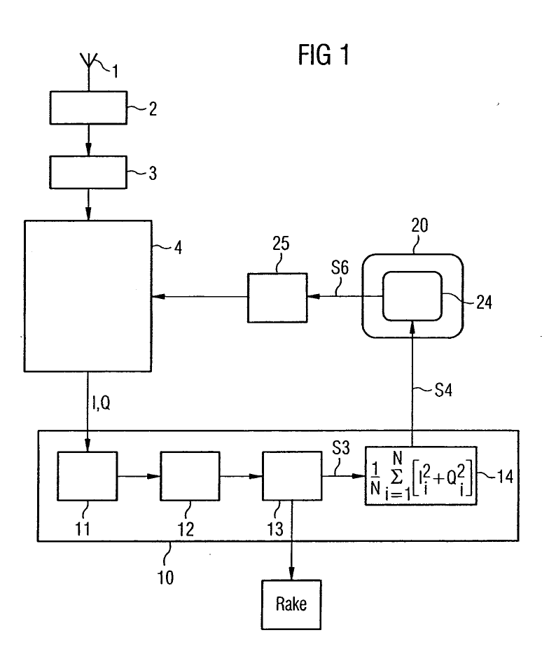

FIG. 1 shows the AGC unit in the receiving section of a UMTS radio receiver. The signals which are received at the antenna 1 are passed via different analogue components such as an antenna switch 2 and a low-noise amplifier 3 to the radio-frequency unit 4, where they are normalized, amplified again and down-mixed to baseband. The signal is sampled by analogue/digital converter 11. A digital filter chain 12 and an RRC filter (root raised cosine) 13 limit the digital signal to a specific bandwidth in accordance with the UMTS Standard. A power calculation unit 14 averages the power of this bandwidth-limited signal S3 over a defined time period. The power calculation unit 14 is in this case in the form of dedicated hardware. The measured value S4 is passed to a digital signal processor (DSP) 20, in which the control algorithm 24, which is implemented in firmware, calculates a new manipulated variable S6. The manipulated variable S6 is passed via a radio-frequency interface 25 to the radio-frequency unit 4. The manipulated variable S6 controls the gain of an amplifier (not illustrated) within the radio-frequency unit 3.

The reception signal strength of the antenna 1, and thus also the power of the bandwidth-limited signal S3, fluctuate over several orders of magnitude according to the UMTS Standard Specification. It is thus advantageous to operate the control algorithm 24 on a logarithmic scale. The averaged signal power is transformed by the power calculation unit 14 to a logarithmic scale, and is made available in the form of an RSSI value (received signal strength indicator) S4, as described in the 3GPP Standard Technical Specification 25.101 for UMTS.

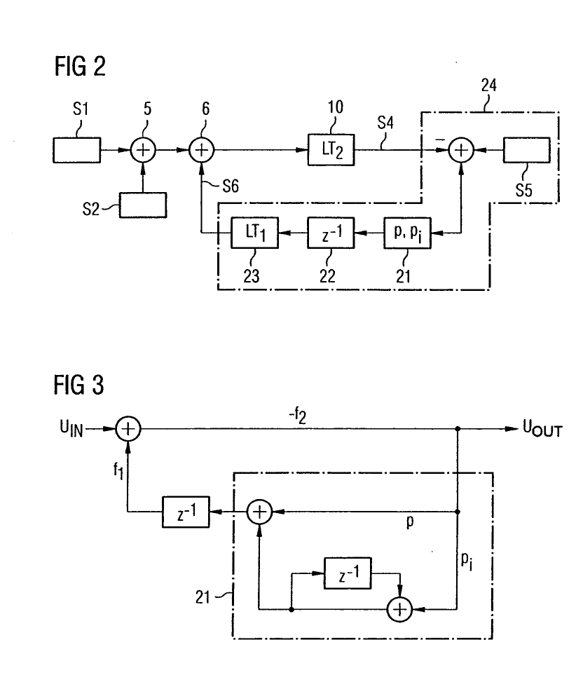

FIG. 2 shows the linear equivalent model of the control loop from FIG. 1 on a logarithmic scale. The received signals S1 are normalized in a suitable manner with the aid of a normalization value S2 by means of a normalization unit 5 which is embedded in the radio-frequency unit 4. The controllable amplifier 6 within the radio-frequency unit 4 is represented an addition process. The transfer function of the digital input circuit 10 is described by a function LT₂. The output value from the function LT₂ is the measured value S4 of the power calculation unit 14 in the form of the RSSI value, which is passed to the control algorithm 24 in the DSP 20. The measured value S4 is normalized with respect to the set value S5, and is supplied to the controller 21. The controller 21 is in this case a proportional integral controller. The parameters p and pᵢ represent the coefficients of the proportional branch and integral branch, respectively, and form the controller settings 21. The z⁻¹ element 22 symbolizes the delay which has occurred during the determination of the mean signal power within the power calculation unit 14. The function LT₁ represents a map of the values at the output of the controller 21 onto the input values of the amplifier 6.

The controller settings 21 are calculated by means of the method according to the invention. In the simplest case, the function LT₂ can be described analytically, for example as a linear or at least partially linear function in the form LT₂=f₂x+C₂. In the same way, LT₁ can be described as LT₁=f₁x+C₁. The transfer function of a PI controller 21 is:

$${H}_{PI} ( z ) = p + \frac{{P}_{i}}{1 - {z}^{- 1}} \qquad ( 1 )$$

The overall transfer function of the control loop can thus be described analytically. The transfer function of the control loop is:

$${H}_{AGC} ( z ) = \frac{{f}_{2} ( 1 - {z}^{- 1} )}{( 1 - {f}_{1} {f}_{2} ( p + {p}_{i} ) ) {z}^{- 1} + {f}_{1} {f}_{2} {pz}^{- 2} - 1} \qquad ( 2 )$$

FIG. 3 shows a normalized equivalent model of the control loop. The coefficients C₁ and C₂ do not qualitatively influence the transfer function, and can thus also be included in the normalization.

The transfer function of the control loop can be described in factorized form as:

$$\begin{matrix}{H}_{AGC} ( z ) = \frac{1 - {z}^{- 1}}{{f}_{1} p ( {R}_{1} - {z}^{- 1} ) ( {R}_{2} - {z}^{- 1} )} where & ( 3 ) \\ {R}_{1 , 2} = \frac{1}{2} - \frac{1}{2 {f}_{1} {f}_{2} p} + \frac{{p}_{i}}{2 p} ∓ \frac{1}{2} \sqrt{\frac{\begin{matrix}1 + 2 {f}_{1} {f}_{2} ( p - {p}_{i} ) + \\ {f}_{1}^{2} {{f}_{2}^{2} ( p + {p}_{i} )}^{2}\end{matrix}}{{f}_{1}^{2} {f}_{2}^{2} {p}^{2}}} & ( 4 )\end{matrix}$$

A typical signal profile of the reception signal strength S1 is now applied in the form of a step function to the transfer function. The signal waveform of the output signal U_{OUT}, which represents the controlled reception signal strength S3 or the measurement variable S4 of the power calculation unit 14, is:

$${u}_{OUT} ( n ) = \frac{1}{{pf}_{1}} \frac{{R}_{2}^{- n - 1} - {R}_{1}^{- n - 1}}{{R}_{1} - {R}_{2}} \qquad ( 5 )$$

where n indicates the computation steps in the AGC.

If the aim is to achieve rapid convergence to the signal value u_{OUT}=0 as the optimality criterion, then this optimality criterion can be incorporated as follows:

If n is odd, the signal strength u_{OUT}(n) becomes zero when:
R₁=−R₂ (6)

The following relationship is therefore obtained with the aid of the definition from equation (4) for the controller settings p and pᵢ and controlled section parameters f₁ and f₂:

$${p}_{i} = \frac{1}{{f}_{1} {f}_{2}} - p \qquad ( 7 )$$

If a given computation step is considered in which n is an even number, the condition from equation (7) leads to a minimum of the signal value u_{OUT}(n) compared with discrepancies from this condition. Furthermore, these minima converge to zero when considered over a number of computation steps. The relationship defined in equation (7) between the controller settings p and pᵢ and the controlled section parameters f₁ and f₂ thus represents a sufficient condition for rapid convergence of the signal value u_{OUT}(n) for all values of n.

Substitution of the above relationship into the signal waveform (equation (5)) results in the following profile:
u_{OUT}(n)=0
if n is an odd number,
   u_{OUT}(n)=−f₂ (f₁f₂p)n/2 (8)
if n is an even number.

The above relationship can thus be used for convergence as rapidly as possible within an integration time interval pᵢ for values of f₂, and possibly f₁, which are predetermined by the physical design of the receiver, and for a chosen value of p. If the coefficients in the function LT₁ 23, in particular f₁, are not predetermined to be fixed, then these can likewise also be included in the optimization process, and thus form further setting values for the controller.

In the general case, the function LT₂ is known as a value table or look-up table. In this case, the overall transfer function of the control loop can be described numerically, and the signal waveform of the controlled reception signal strength S3 can be determined as a function of the controller settings 21 and of the coefficients of the function LT₁ 23.

The determination of the controller settings 21 for different environmental conditions, which are represented, by way of example, by different coefficients of the function LT₂, is carried out in advance. In this case, a desired convergence response may be predetermined, expressed by the convergence conditions to be applied. The controller settings determined in this way are stored in the DSP 20, and can be called by the control algorithm 24, and supplied to the controller 21, during operation. The controller 21 can thus be switched between different radio conditions, such as operating modes, environmental conditions, desired optimality criteria, etc.

1. A method for determination of controller settings for a control loop for controlling the reception signal strength in a radio receiver, with the transfer function being known at least approximately as a function for that part of the signal path of the radio receiver which forms the controlled section of the control loop, comprising the step of:
determining the controller settings computationally by optimization of the overall transfer function of the control loop with respect to a desired optimality criterion, taking into account the known function.

2. The method according to claim 1, wherein the optimality criterion predetermines a desired convergence response of the controlled reception signal strength.

3. The method according to claim 2, wherein the desired convergence response requires convergence of the controlled reception signal strength essentially within the time period required for the controller to determine a new manipulated variable.

4. The method according to claim 2, wherein the desired convergence response is a predetermined time profile on which the controlled reception field strength reaches its set value.

5. The method according to claim 1, wherein the function is stored in one or more look-up tables.

6. The method according to claim 1, wherein
the function is defined by one or more analytical functions, in particular linear or partially linear functions, and
the coefficients of the analytical functions are known parameters for the controlled section.

7. The method according to claim 1, wherein the overall transfer function of the control loop is described by one or more analytical functions, in particular by linear or partially linear functions.

8. The method according to claim 6, wherein the overall transfer function of the control loop is described by one or more analytical functions, in particular by linear or partially linear functions.

9. The method according to claim 1, comprising the steps of:
determining first controller settings relating to a first optimality criterion;
determining second controller settings relating to a second optimality criterion, with the first optimality criterion being used for optimization of the overall transfer function for a first operating mode of the radio receiver, and the second optimality criterion being used for optimization of the overall transfer function for a second operating mode of the radio receiver.

10. The method according to claim 9, wherein the radio receiver processes signals in accordance with the Universal Mobile Telecommunications System (UMTS) Standard.

11. The method according to claim 10, wherein the first operating mode is the normal mode, and the second operating mode is the compression mode for UMTS.

12. The method according to claim 2, comprising the steps of:
determining first controller settings relating to a first optimality criterion;
determining second controller settings relating to a second optimality criterion, with the first optimality criterion being used for optimization of the overall transfer function for a first operating mode of the radio receiver, and the second optimality criterion being used for optimization of the overall transfer function for a second operating mode of the radio receiver;
wherein the desired convergence response requires the controlled signal strength to converge essentially in a time which is considerably shorter than the time slot duration.

13. The method according to claim 1, comprising the steps of:
first controller settings relating to a first optimality criterion are determined;
second controller settings relating to a second optimality criterion are determined, with the first optimality criterion being used for optimization of the overall transfer function for a first environmental condition of the radio receiver, and the second optimality criterion being used for optimization of the overall transfer function for a second environmental condition of the radio receiver.

14. The method according to claim 13, wherein the first and the second environmental condition are defined by different relative speeds of the radio receiver with respect to the transmission station.

15. The method according to claim 1, wherein the overall transfer function is furthermore influenced by a further transmission path which represents a map of the values of the controller output onto suitable values of the manipulated variable for the controlled section.

16. The method according to claim 15, wherein
the further transmission path is defined by a further linear function or a further partially linear function, and
the coefficients of the further linear or partially linear function are either chosen as a function of the value range of the controller output or are calculated as further setting values during the computational determination of the controller setting.

17. The method according to claim 1, wherein that section of the signal path of the radio receiver which forms the controlled section of the control loop comprises a variable gain analogue amplifier, an analogue/digital converter, a digital filter and a power calculation unit.

18. The method according to claim 17, wherein the manipulated variable for the control loop controls the gain of the analogue amplifier, and suitable values for the manipulated variable are taken from the controller output directly or after mapping according to claim 14 or 15.

19. The method according to claim 1, wherein the controller has a proportional branch and an integral branch, and the controller settings comprise the coefficients for the proportional branch and for the integral branch.

20. A method for controlling the reception signal strength in a radio receiver by means of a control loop, which comprises a controller with variable controller settings which can be predetermined, comprising the steps of:
operating the controller with first controller settings;
operating the controller with second controller settings, which are not the same as the first controller settings.

21. The method according to claim 20, wherein the radio receiver processes signals in accordance with the Universal Mobile Telecommunications System (UMTS) Standard.

22. A method for controlling the reception signal strength in a radio receiver by means of a control loop, which comprises a controller with variable controller settings which can be predetermined, comprising the steps of:
operating the controller with first controller settings;
operating the controller with second controller settings, which are not the same as the first controller settings;
wherein the first and second controller settings are calculated in advance by means of method for determination of controller settings for a control loop for controlling the reception signal strength in a radio receiver, with the transfer function being known at least approximately as a function for that part of the signal path of the radio receiver which forms the controlled section of the control loop, comprising the steps of:
determining the controller settings computationally by optimization of the overall transfer function of the control loop with respect to a desired optimality criterion, taking into account the known function, and
storing the controller settings in the radio receiver.

23. The method according to claim 22, wherein the first and second controller settings are provided in the form of first and second parameter sets and, if there is a change in the radio conditions, a change is made to a different parameter set, with the radio conditions comprising at least one of a variable of the group consisting of:
the signal at the controller output;
the desired optimality criterion;
the transmission mode of the radio receiver;
the environmental conditions of the radio receiver; and
the relative speed of the radio receiver with respect to the base station.
